(19) United States
(12) Patent Application Publication
(10) Pub. No.: US 2010/0174943 A1
(43) Pub. Date: Jul. 8, 2010

(54) METHOD FOR RESTORING CLIENT OPERATING SYSTEM-BASED SYSTEM, VIRTUAL MACHINE MANAGER AND SYSTEM USING THE SAME

(75) Inventors: Chunmei Liu, Beijing (CN); Jun Chen, Beijing (CN); Kai Wang, Beijing (CN)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: LENOVO (BEIJING) LIMITED, Beijing (CN)

(21) Appl. No.: 12/683,126

(22) Filed: Jan. 6, 2010

(30) Foreign Application Priority Data
Jan. 7, 2009 (CN) 20091007611.X

(51) Int. Cl. G06F 11/08

(52) U.S. Cl. 714/15; 718/1; 714/E11.03

(57) ABSTRACT

The present invention provides a method for restoring a client operating system-based system, a virtual machine manager and a virtual machine manager system using the same. The method comprises steps of: receiving a restoration instruction for the client operating system and suspending running the client operating system after receiving the restoration instruction, the restoration instruction including a preset restoration point; determining a first memory snapshot and a first incremental file corresponding to the restoration point, the first memory snapshot being a memory snapshot for the client operating system, which is created when setting the restoration point, and the first incremental file being an incremental file, which is mapped as the first hard disk when setting the restoration point; re-mapping the first incremental file as the first hard disk; and performing a snapshot recovery based on the first memory snapshot. With the present invention, system restoration may be performed rapidly.

### BACKGROUND OF THE INVENTION

1. Field of the Invention

The present invention relates to a virtual machine, more particularly to a method for restoring a client operating system-based system, a virtual machine manager and a virtual machine system using the same.

2. Description of Prior Art

In some unexpected cases, an operating system of a computer would enter into an unexpected state after a user installs some software or performs certain operations. In this case, it is often needed to use a previous system backup to restore the operating system, particularly return to a backup state made previously.

For conventional system restoration technologies, it is needed to restore an operating system on a hard disk using previous backup files. After the restoration, it is further needed to restart the computer. In this way, the system restoration spends much time with low efficiency.

### SUMMARY OF THE INVENTION

Embodiments of the present invention aim to provide a method for restoring a client operating system-based system, a virtual machine manager and a virtual machine system for rapidly restoring an operating system.

In view of this, an embodiment of the present invention provides a solution as follows: a method for restoring a client operating system, which runs on a virtual machine manager and comprises a first hard disk, the first hard disk being obtained by the virtual machine manager mapping an incremental file of an incremental file system provided in a physical hard disk, the method comprising steps of:
receiving a restoration instruction for the client operating system and suspending running the client operating system after receiving the restoration instruction, the restoration instruction including a preset restoration point;
determining a first memory snapshot and a first incremental file corresponding to the restoration point, the first memory snapshot being a memory snapshot of the client operating system, which is created when setting the restoration point, and the first incremental file being an incremental file, which is mapped as the first hard disk when setting the restoration point;
re-mapping the first incremental file as the first hard disk; and
performing a snapshot recovery based on the first memory snapshot.

Preferably, the method further comprises a step of:
continuing running the client operating system after the snapshot recovery.

Preferably, according to the method, the memory snapshot is adapted to record a hardware state and a memory state of the client operating system. In this case, the step of performing the snapshot recovery comprises recovering the hardware state and the memory state of the client operating system based on the first memory snapshot.

Preferably, according to the method, after the snapshot recovery, a second incremental file is further created based on the first incremental file. The second incremental file is then mapped as the first hard disk.

Preferably, according to the method, the incremental file system is a QEMU Copy-on-Write (qcow) file system or a Zettabyte File System (ZFS) file system.

An embodiment of the present invention further provides a virtual machine manager, comprising:
a mapping module adapted to map an incremental file of an incremental file system as a first hard disk for a client operating system running on the virtual machine manager, the incremental file system being provided in a physical hard disk;
a reception module adapted to receive a restoration instruction for the client operating system, the restoration instruction including a preset restoration point;
a restoration relationship corresponding module adapted to determine a first memory snapshot and a first incremental file corresponding to the restoration point, the first memory snapshot being a memory snapshot of the client operating system, which is created when setting the restoration point, and the first incremental file being an incremental file, which is mapped as the first hard disk when setting the restoration point;
a control module adapted to suspend running the client operating system after the reception module receives the restoration instruction; and
a restoration point recovery module adapted to re-map the first incremental file as the first hard disk after the control module suspends running the client operating system, and to perform a snapshot recovery based on the first memory snapshot.

Preferably, according to the virtual machine manager, the control module comprises a start-up sub-module adapted to continue running the client operating system after the snapshot recovery performed by the restoration point recovery module.

Preferably, according to the virtual machine manager, the memory snapshot is adapted to record a hardware state and a memory state of the client operating system. In this case, the restoration point recovery module comprises a snapshot recovery sub-module, which is adapted to recover the hardware state and the memory state of the client operating system based on the first memory snapshot.

Preferably, according to the virtual machine manager, the restoration point recovery module comprises a creation module, which is adapted to create a second incremental file based on the first incremental file after the snapshot recovery and to map the second incremental file as the first hard disk.

An embodiment of the present invention further provides a virtual machine system, comprising:
a hardware platform at least comprising a CPU, a memory and a physical hard disk;
a virtual machine manager running on the hardware platform; and
a client operating system running on the virtual machine manager, the client operating system comprising a first hard disk.

The virtual machine manager comprises:
a mapping module adapted to map an incremental file of an incremental file system as the first hard disk, the incremental file system being provided in the physical hard disk;
a reception module adapted to receive a restoration instruction for the client operating system, the restoration instruction including a preset restoration point;
a restoration relationship corresponding module adapted to determine a first memory snapshot and a first incremental file corresponding to the restoration point, the first memory snapshot being a memory snapshot of the client operating system, which is created when setting the restoration point, and the first incremental file being an incremental file, which is mapped as the first hard disk when setting the restoration point;
a control module adapted to suspend running the client operating system after the reception module receives the restoration instruction; and
a restoration point recovery module adapted to re-map the first incremental file as the first hard disk after the control module suspends running the client operating system, and to perform a snapshot recovery based on the first memory snapshot.

Preferably, according to the virtual machine system, the control module comprises a start-up sub-module, which is adapted to continue running the client operating system after the snapshot recovery performed by the restoration point recovery module.

Preferably, according to the virtual machine system, the memory snapshot is adapted to record a hardware state and a memory state of the client operating system. The restoration point recovery module comprises a snapshot recovery sub-module, which is adapted to recover the hardware state and the memory state of the client operating system based on the first memory snapshot.

Preferably, according to the virtual machine system, the restoration point recovery module comprises a creation module, which is adapted to create a second incremental file based on the first incremental file after the snapshot recovery and to map the second incremental file as the first hard disk.

With the method for restoring the client operating system-based system, the virtual machine manager and system according to the embodiments of the present invention, which use the virtual machine technology, the present invention may firstly suspend the client operating system and then re-run the client operating system, in such a manner that the time for restarting the operating system can be saved. Furthermore, the current image file of the client operating system may be rapidly and simply recovered by using a reference file of the incremental file system when setting the restoration point without hard disk recovery, thus saving the time for recovering the operating system. Moreover, the memory snapshot function of the virtual machine may enable the rapid restoration for the client operating system.

### BRIEF DESCRIPTION OF THE DRAWINGS

FIG. 1 shows a flowchart of a method for restoring a system according to an embodiment of the present invention; and

FIG. 2 shows a structural schematic diagram of a virtual machine system according to an embodiment of the present invention.

### DETAILED DESCRIPTION OF THE PREFERRED EMBODIMENTS

The present invention provides a method for rapidly restoring a client operating system by using the virtual machine technology. In the following, a further description will be given to the present invention by means of its specific embodiments with reference to the drawings.

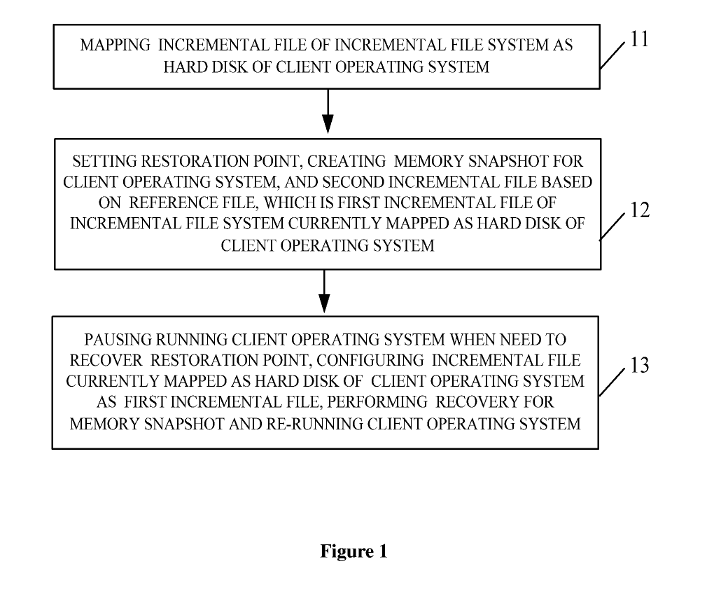

As shown in FIG. 1, a method for restoring a client operating system-based system using the virtual machine technology according to an embodiment of the present invention is applied in a virtual machine system configured with a client operating system. The method particularly comprises the following steps.

At step 11, an incremental file system is configured when creating a hard disk for the client operating system, and an incremental file of the incremental file system is mapped as the hard disk for the client operating system.

When creating the hard disk for the client operating system, an incremental file of an incremental file system of a virtual machine in a base layer is mapped as the hard disk for the client operating system, the incremental file system being provided in a real physical hard disk. The client operating system may use any file system supported by itself, such as FAT32, NTFS and the like. However, the client operating system's read-write operations for its own file systems are all mapped to incremental files of an incremental file system. The incremental file system may configure a currently used incremental file as a reference file, based on which a new incremental file may be created. The new incremental file is adapted to store the client operating system's subsequent wire operations for the hard disk. Particularly, after creating the new incremental file, the client operating system's modifications on data of its own file systems are all recorded in the new incremental file, instead of being recorded in the previous reference file.

In this embodiment, the incremental file system may be a qcow or a ZFS file system. However, it will be appreciated that the present invention is not limited to the qcow or the ZFS file system, and any other incremental file systems may be applicable in the present invention. The qcow is a QEMU image format. The QEMU is a complete PC system-oriented open source emulative technique, which may be used for virtualization of the client operating system, or may be used as a complete machine simulator. In this embodiment, the client operating system may be stored in a hard disk in a manner of Disk Image in qcow format.

At step 12, a memory snapshot for the client operating system is created when it is needed to set a restoration point for the client operating system, and a second incremental file is created based on a reference file, which is a first incremental file of the incremental file system currently mapped as the hard disk of the client operating system. The memory snapshot may correspond to the restoration point.

The memory snapshot is adapted to record a hardware state and a memory state of the client operating system, such as state values of various registers. The snapshot is stored in the hard disk. In this embodiment, the first incremental file and the second incremental file are both in an incremental file system format.

At step 13, the client operating system is suspended when it is needed to recover the restoration point, an incremental file of the incremental file system currently mapped as the hard disk of the client operating system is configured as the first incremental file, particularly the first incremental file is re-mapped as the hard disk of the client operating system. Then a snapshot recovery is performed based on the memory snapshot and the client operating system is re-ran thereafter.

When the snapshot recovery is completed, a third incremental file based on the first incremental file may be further created and then mapped as the hard disk of the client operating system. The third incremental file is adapted to record the client operating system's modifications on its file systems after re-running the client operating system.

The step of performing the snapshot recovery may comprise recovering the hardware state and the memory state of the client operating system based on the memory snapshot. When the snapshot recovery is completed, the client operating system is recovered to the state when setting the restoration point by re-running the client operating system, so as to implement rapid restoration for the client operating system.

In this embodiment, a user may set more than one restoration points, each of which re-creates a new incremental file by taking an incremental currently mapped as the hard disk of the client operating system as its reference. In this case, it is further needed to create a memory snapshot corresponding to the restoration point.

Thus, this embodiment is based on the virtual machine technology. Specifically, this embodiment firstly suspends the client operating system and then re-runs the client operating system, in such a manner that the time for restarting the operating system can be saved. Furthermore, the current image file of the client operating system is rapidly and simply recovered by using a reference file of the incremental file system when setting the restoration point without hard disk recovery, thus saving the time for recovering the operating system. Moreover, the memory snapshot function of the virtual machine enables the rapid restoration for the client operating system.

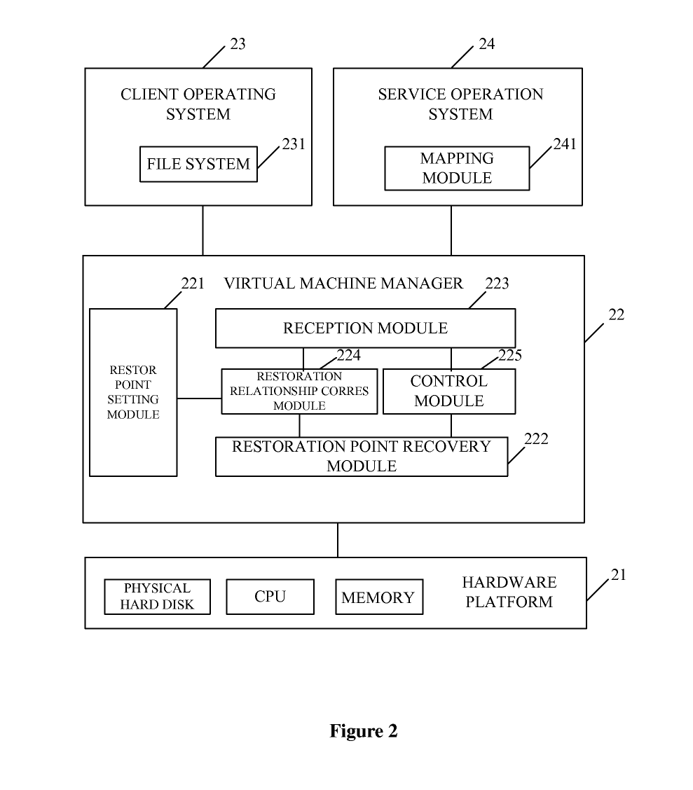

This embodiment further provides a virtual machine manager and a virtual machine system. As shown in FIG. 2, the virtual machine system comprises:
a hardware platform 21 at least comprising a CPU, a memory and a physical hard disk;
a virtual machine manager 22 running on the hardware platform; and
a client operating system 23 and a Service Operation System (SOS) 24 running on the virtual machine manager 22.

The SOS 24 comprises a mapping module 241. The mapping module 241 is adapted to map a disk image as a hard disk of the client operating system 23 and manage the disk image in accordance with an incremental file system. Particularly, the mapping module 241 is adapted to map an incremental file of the incremental file system as the hard disk of the client operating system 23. The incremental file may be a disk image file. The mapping module 241 may be a QEMU simulator. A file system 231 of the client operating system 23 may be any file system supported by the client operating system 23, such as NTFS, FAT32 and the like. The client operating system 23's reading/writing operations for the file system 231 are all mapped to a specific incremental file, which is an incremental file of the incremental file system currently mapped as the hard disk of the client operating system 23.

The virtual machine manager 22 comprises:
a restoration point setting module 221, which is adapted to set a restoration point for the client operating system 23, create a memory snapshot for the client operating system 23, which corresponds to the restoration point, and create a second incremental file based on a reference file. The reference file is a first incremental file of the incremental file system currently mapped as the hard disk of the client operating system 23;
a reception module 223, which is adapted to receive a restoration instruction for the client operating system 23, the restoration instruction including a preset restoration point;
a restoration relationship corresponding module 224, which is adapted to determine a first memory snapshot and a first incremental file corresponding to the restoration point, the first memory snapshot being a memory snapshot of the client operating system, which is created when setting the restoration point, and the first incremental file being an incremental file, which is mapped as the first hard disk when setting the restoration point;
a control module 225, which is adapted to suspend running the client operating system 23 after the reception module 223 receives the restoration instruction; and
a restoration point recovery module 222, which is adapted to re-map the first incremental file as the first hard disk after the control module suspends running the client operating system 23, and to perform a snapshot recovery based on the first memory snapshot.

The control module 225 may comprise a start-up sub-module. The start-up sub-module is adapted to continue running the client operating system 23 after the snapshot recovery performed by the restoration point recovery module 222.

Here, the restoration point recovery module comprises a creation module adapted to create a third incremental file based on the first incremental file after the snapshot recovery and to map the third incremental file as the hard disk of the client operating system.

Here, the memory snapshot is adapted to record a hardware state and a memory state of the client operating system. The restoration point recovery module 222 comprises a snapshot recovery sub-module adapted to recover the hardware state and the memory state of the client operating system based on the memory snapshot. In this embodiment, the incremental file system may be a qcow or a ZFS file system. However, it shall be appreciated that the present invention is not limited to the qcow or the ZFS file system, and any other incremental file systems may be applicable in the present invention.

Furthermore, the mapping unit 241 may be provided in the virtual machine manager 22.

In summary, with the method for restoring the client operating system-based system, the virtual machine manager and the virtual machine system according to the embodiment of the present invention, which use the virtual machine technology, it is unnecessary to restart a system and recover hard disk files during the restoration operations of the system, thus the system may be restored rapidly.

The foregoing description gives only the embodiments of the present invention. It will be appreciated by those skilled in the art that many improvements and modifications can be made without departing from the principles and spirits of the invention, and they shall fall into the scope of the present invention.

What is claimed is:

1. A method for restoring a client operating system running on a virtual machine manager, the client operating system comprising a first hard disk, which is obtained by the virtual machine manager mapping an incremental file of an incremental file system, and the incremental file system being provided in a physical hard disk, wherein the method comprises steps of:
receiving a restoration instruction for the client operating system and suspending running the client operating system after receiving the restoration instruction, the restoration instruction including a preset restoration point;
determining a first memory snapshot and a first incremental file corresponding to the restoration point, the first memory snapshot being a memory snapshot for the client operating system, which is created when setting the restoration point, and the first incremental file being an incremental file, which is mapped as the first hard disk when setting the restoration point;
re-mapping the first incremental file as the first hard disk; and
performing a snapshot recovery based on the first memory snapshot.

2. The method according to claim 1, further comprising a step of:
continuing running the client operating system after the snapshot recover.

3. The method according to claim 1, wherein, the memory snapshot is adapted to record a hardware state and a memory state of the client operating system, and wherein the step of performing the snapshot recover comprises recovering the hardware state and the memory state of the client operating system based on the first memory snapshot.

4. The method according to claim 2, wherein, the memory snapshot is adapted to record a hardware state and a memory state of the client operating system, and wherein the step of performing the snapshot recover comprises recovering the hardware state and the memory state of the client operating system based on the first memory snapshot.

5. The method according to claim 1, wherein, after the snapshot recover, a second incremental file is further created based on the first incremental file, and the second incremental file is then mapped as the first hard disk.

6. The method according to claim 1, wherein, the incremental file system is a qcow file system or a ZFS file system.

7. A virtual machine manager, comprising:
a mapping module adapted to map an incremental file of an incremental file system as a first hard disk of a client operating system running on the virtual machine manager, the incremental file system being provided in a physical hard disk;
a receiving module adapted to receive a restoration instruction for the client operating system, the restoration instruction including a preset restoration point;
a restoration relationship corresponding module adapted to determine a first memory snapshot and a first incremental file corresponding to the restoration point, the first memory snapshot being a memory snapshot for the client operating system, which is created when setting the restoration point, and the first incremental file being an incremental file, which is mapped as the first hard disk when setting the restoration point;
a control module adapted to suspend running the client operating system after the reception module receives the restoration instruction; and
a restoration point recovery module adapted to re-map the first incremental file as the first hard disk after the control module suspends running the client operating system, and to perform a snapshot recovery based on the first memory snapshot.

8. The virtual machine manager according to claim 7, wherein, the control module comprises a start-up sub-module adapted to continue running the client operating system after the snapshot recovery performed by the restoration point recovery module.

9. he virtual machine manager according to claim 7, wherein, the memory snapshot is adapted to record a hardware state and a memory state of the client operating system, and wherein the restoration point recovery module comprises a snapshot recovery sub-module adapted to recover the hardware state and the memory state of the client operating system based on the first memory snapshot.

10. The virtual machine manager according to claim 8, wherein, the memory snapshot is adapted to record a hardware state and a memory state of the client operating system, and wherein the restoration point recovery module comprises a snapshot recovery sub-module adapted to recover the hardware state and the memory state of the client operating system based on the first memory snapshot.

11. The virtual machine manager according to claim 7, wherein, the restoration point recovery module comprises a creation module adapted to create a second incremental file based on the first incremental file after the snapshot recovery and to map the second incremental file as the first hard disk.

12. A virtual machine system, comprising:
a hardware platform at least comprising a CPU, a memory and a physical hard disk;
a virtual machine manager running on the hardware platform; and
a client operating system running on the virtual machine manager, the client operating system comprising a first hard disk,
wherein the virtual machine manager comprises:
a mapping module adapted to map an incremental file of an incremental file system as the first hard disk, the incremental file system being provided in the physical hard disk;
a reception module adapted to receive a restoration instruction for the client operating system, the restoration instruction including a preset restoration point;
a restoration relationship corresponding module adapted to determine a first memory snapshot and a first incremental file corresponding to the restoration point, the first memory snapshot being a memory snapshot for the client operating system, which is created when setting the restoration point, and the first incremental file being an incremental file, which is mapped as the first hard disk when setting the restoration point;
a control module adapted to suspend running the client operating system after the reception module receives the restoration instruction; and
a restoration point recovery module adapted to re-map the first incremental file as the first hard disk after the control module suspends running the client operating system, and to perform a snapshot recovery based on the first memory snapshot.

13. The virtual machine system according to claim 12, wherein, the control module comprises a start-up sub-module adapted to continue running the client operating system after the snapshot recovery performed by the restoration point recovery module.

14. The virtual machine system according to claim 12, wherein, the memory snapshot is adapted to record a hardware state and a memory state of the client operating system, and wherein the restoration point recovery module comprises a snapshot recovery sub-module adapted to recover the hardware state and the memory state of the client operating system based on the first memory snapshot.

15. The virtual machine system according to claim 13, wherein, the memory snapshot is adapted to record a hardware state and a memory state of the client operating system, and wherein the restoration point recovery module comprises a snapshot recovery sub-module adapted to recover the hardware state and the memory state of the client operating system based on the first memory snapshot.

16. The virtual machine system according to claim 12, wherein, the restoration point recovery module comprises a creation module adapted to create a second incremental file based on the first incremental file and to map the second incremental file as the first hard disk.
